(19) United States
(12) Patent Application Publication
(10) Pub. No.: US 2002/0000940 A1
(43) Pub. Date: Jan. 3, 2002

(54) AN ANTENNA DEVICE, A METHOD FOR MANUFACTURING AN ANTENNA DEVICE AND A RADIO COMMUNICATION DEVICE INCLUDING AN ANTENNA DEVICE

(76) Inventors: STEFAN MOREN, KISTA (SE); OLOV EDVARDSSON, TABY (SE)

Correspondence Address: JACOBSON PRICE HOLMAN & STERN, PROFESSIONAL LIMITED LIABILITY COMPANY, 400 SEVENTH STREET NW, WASHINGTON, DC, 20004

(21) Appl. No.: 09/336,745

(22) Filed: Jun. 21, 1999

(30) Foreign Application Priority Data
Jun. 24, 1998 (SE) 9802246-0

(51) Int. Cl. H01Q 1/24; H01Q 1/36

(52) U.S. Cl. 343/702; 343/895

(57) ABSTRACT

An antenna device for transmitting/receiving RF waves to be arranged in a radio communication device, comprising: a carrier (10) having first and second surfaces carrying a radiating structure (20) on the first surface; a feed portion (25) being connectable to transceiver circuits of the radio communication device and being arranged on the carrier (10) and forming a part of the radiating structure (20); and a ground plane means. The carrier has, in a first plane essentially perpendicular to the first surface, a cross section where the first surface exhibits at least a first curved portion (12). Further, the carrier has, in a second plane essentially perpendicular to the first plane and essentially perpendicular to the first surface, a cross section where the first surface exhibits at least a second curved portion (11, 13). Moreover, at least two curved portions meet.

Further a method for manufacturing an antenna device is disclosed. In the method, at least a part of the carrier is formed by means of a die having essentially the same shape as a portion of an inner wall of a housing of the radio communication device.

Also a hand portable radio communication device, including an antenna device is disclosed.

### FIELD AND BACKGROUND OF THE INVENTION

The invention relates to an antenna device for transmitting/receiving RF waves to be arranged in a radio communication device, comprising: a carrier having first and second surfaces carrying a radiating structure on the first surface; a feed portion being connectable to transceiver circuits of the radio communication device and being arranged on the carrier and forming a part of the radiating structure; and a ground plane means. The invention also relates to a method for manufacturing such an antenna device. Further the invention relates to a radio communication device including such an antenna device.

In the radio communication systems today there is an increasing demand for availability and small sizes of the user units. This puts requirements on the antenna devices to be compact and to have good antenna performance. Antenna means including a helical element in combination with an extendable whip antenna have been used for hand-portable cellular telephones in order to achieve compact dimensions and durability while maintaining high efficiency in call mode. Interest has also been focused on antenna devices mounted inside the housing of hand-portable cellular telephones. Thereby, protruding antenna parts are avoided, and lower SAR (specific absorption rate, in the human body) is generally obtained.

### RELATED ART

WO 97/06578 discloses a fractal antenna on a flexible substrate, which is to be placed in a transceiver. However, due to its flexibility the substrate is difficult to place in a transceiver.

U.S. Pat. No. 3,956,701 discloses a paging receiver with a swivel clip and an antenna device to be placed in the receiver, and which is operable in the different positions the receiver can take. The antenna means comprises an electrical conductor on a flexible dielectric base. Also here, it is difficult to place the antenna device in the receiver, since its base is flexible. Further, the antenna device carried on a flexible substrate does not ensure stability.

### SUMMARY OF THE INVENTION

A main object of the invention is to provide an antenna device which is robust, stable, easy to mount, easy to connect, arranged to efficiently use the available space, and having good antenna performance.

It is also an object of the invention to provide an antenna device which has a low SAR (specific absorption rate in the human body).

It is also an object of the invention to provide an antenna device which has a simple design, is simple to manufacture, can be produced at low cost, and is suited for automatized manufacturing.

These and other objects are attained by an antenna device according to the appended claims.

By the carrier having, in the second plane, a cross section where the first surface further exhibits a third curved portion,

by the carrier having, in the first plane, a cross section where the first surface further exhibits a fourth curved portion, and

by the curved portions surrounding an essentially planar or very smoothly curved portion, where the carrier has wall portions around the curved portions, each wall portion being provided with a rim formed outside bent portions being approximately 90°, at a side of the wall opposite to that of the curved portion, an antenna device is achieved which is more robust and stable and easy to mount.

By the features that a ground plane means support is formed from the same sheet-like material as the carrier, and a conductive structure, possibly conductively connectable to signal ground of the transceiver circuits of the radio communication device, being arranged on the ground plane means support, and

that a ground plane means support is formed from the same sheet-like material as the carrier,

a conductive structure, possibly capacitively connectable to signal ground of the transceiver circuits of the radio communication device, being arranged on the ground plane means support, an antenna device is achieved in which the available space is more effectively used and in which the ground plane means is effectively connectable to signal ground.

By the features that a bending initiator is arranged between the carrier and the ground plane means support in order to enable the ground plane means support to be bent approximately 180° in relation to the carrier, an antenna device is achieved which is easy to manufacture and has a robust and stable construction.

By the features that the ground plane means has one surface which is formed essentially conform with a printed circuit board of the radio communication device, the ground plane means is arranged to be mounted in connection with said printed circuit board, an antenna device is achieved in which the available space is more effectively used and in which the PCB is effectively protected from induced currents.

By the features that the radiating structure comprises at least one of the radiating structures selected from the group consisting of meander patterns, loops, patches, bent dipoles and fractals, and that the radiating structure extends over at least one of said curved portions, an antenna device is achieved which is easier to connect to the transceiver circuits.

It is also an object of the invention to provide a method for manufacturing an antenna device, which method is simple cost effective and is simple to adapt to different optimal shapes of the antenna device.

It is also an object of the invention to provide a method for manufacturing an antenna device, which has short development time to production.

These and other objects are attained by the method according to the invention.

It is also an object of the invention to provide a hand portable radio communication device which is provided with an antenna device which is robust, stable, easy to mount, easy to connect, arranged to efficiently use the available space, and having good antenna performance

It is also an object of the invention to provide a hand portable radio communication device which is provided with an antenna device which has a low SAR (specific absorption rate in the human body).

These and other objects are attained by a hand portable radio communication device according to the invention.

### BRIEF DESCRIPTION OF THE DRAWINGS

FIG. 1 is a diagrammatic view of a radiating structure and a carrier in a first embodiment, according to the invention.

FIG. 2 is a diagrammatic view of a radiating structure and a carrier in a second embodiment, according to the invention.

FIG. 3 is a diagrammatic view of a radiating structure and a carrier in a third embodiment, according to the invention.

FIG. 4 is a diagrammatic view of a radiating structure and a carrier in a fourth embodiment, according to the invention.

FIG. 5 is a cross sectional view taken at V-V in FIG. 1.

FIG. 6 is a cross sectional view taken at VI-VI in FIG. 1.

FIG. 7 is a cross sectional view taken at VII-VII in FIG. 2.

FIG. 8 is a cross sectional view taken at VIII-VIII in FIG. 3.

FIG. 9 is a cross sectional view taken at IX-IX in FIG. 3.

FIG. 10 is a diagrammatic view of a radiating structure and a carrier in a fifth embodiment, according to the invention.

FIG. 11 is a diagrammatic view of a radiating structure and a carrier in a sixth embodiment, according to the invention.

FIG. 12 is a cross sectional view taken at XII-XII in FIG. 11.

FIG. 13 is a diagrammatic view of an apparatus for forming a carrier according to the invention in a process according the invention.

FIG. 14 is a diagrammatic view of a carrier and a ground plane means support according to the invention.

FIG. 15 is a diagrammatic cross sectional view of a mobile telephone with an antenna device according to the invention.

### DESCRIPTION OF PREFERRED EMBODIMENTS

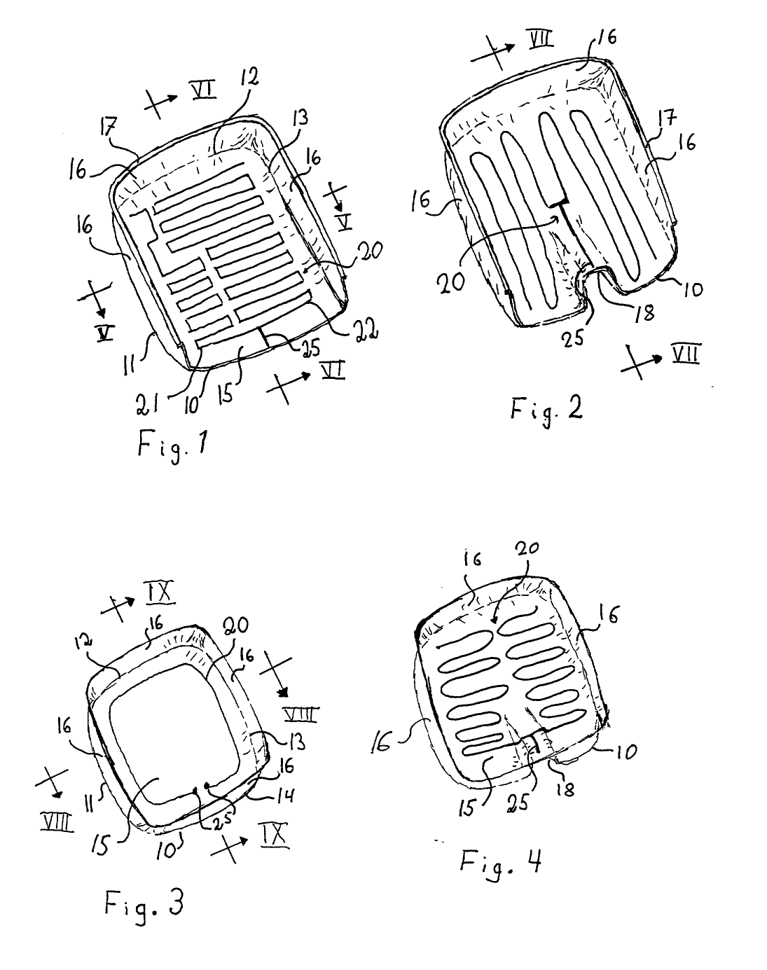

With reference to FIG. 1, a radiating structure 20 on a carrier 10 included in an antenna device for transmitting and receiving RF waves in connection to a radio communication device, according to the invention is diagrammatically shown. The carrier 10 is relatively thin, having a thickness being in the range some tenth of a millimeter to a few millimeters, preferably 0.2-1 millimeter. Preferably the carrier 10 is made from a dielectric polymeric sheet-like material, which includes a band shaped material cut into suitable pieces. As seen in the figure, the carrier is formed so as to define upwardly curved portions 11-13 limiting an essentially planar or very smoothly curved portion 15. Around the curved portions 11-13 the carrier 10 continues in low wall portions 16. In FIG. 1 three curved portions 11-13 are shown, so as to leave one side of the essentially planar or very smoothly curved portion 15 open.

The sheet-like material from which the carrier is formed, is preferably a relatively flexible material, which is easy to handle. However, by the arrangement of the curved portions the carrier will obtain a high degree of stiffness and stability, which makes it suitable as a component to be easily mounted in a radio communication device.

The carrier 10, which has a trough-shape with three wall portions 16, i.e. one wall left out, is provided with a radiating structure 20 covering at least a part of the essentially planar or very smoothly curved portion 15 on a first surface of the carrier 10, which in this case is the surface surrounded by the wall portions 16. The radiating structure 20, which is attached to the support by e.g. adhesion, fusing or similar, comprises two meander patterns 21, 22, and a feed portion 25. However, the meander patterns or one of the patterns could be replaced by a conductive loop, dipole, patch element etc. The feed portion is connected to the transceiver circuits of the radio communication device by suitable connection means. Such means could be conductive springs or clips, conductive pads or pogo-pins (spring loaded pins), connecting the feed portion to a PCB (printed circuit board) carrying transceiver circuits.

For mounting purposes, it is suitable that the top of each wall portion 16 is provided with a rim 17. The rims are formed outside bent portions being approximately 90°, at the top portions of the wall portions 16. The rims 17 serves as a support for the carrier or a contact surface, for e.g. a PCB (printed circuit board). The rims 17 can be used for fastening purposes e.g. by snap action or gripping. Furthermore, the rims 17 improve the stability and stiffness of the carrier.

In FIG. 2 a second embodiment of a radiating structure 20 and a carrier 10 included in an antenna device is shown. It differs from the previous embodiment in that the radiating pattern is different, even if it could be the same as in the previous embodiment, and that an elevation 18 is arranged to protrude from the portion 15. The feed portion 25 is arranged on the elevation 18, in order to shorten the distance from the feed portion 25 to a PCB contacting or being adjacent to the rims 17, and to which the feed portion is to be connected. The elevation 18 is preferably formed to be elastic, so as to exert a pressure on a contacting surface or component. Hereby a contact pressure can be created between the feed portion and the contacting part(s) of a PCB, and/or possible intermediate connection means. This can be made by letting a portion of the elevation 18 protrude above the plane of the rims 17.

FIG. 3 shows a third embodiment of the radiating structure 20 and a carrier 10, according to the invention. In this embodiment the portion 15 is surrounded by four upwardly curved portions 11-14 and four wall portions 16. No rims are shown on the tops of the wall portions 16, even if the wall portions 16 could be provided with rims as in the previous embodiments. The radiating structure 20 may be of the same kind as in the previous embodiments, even if a radiating loop is shown. Otherwise this embodiment is similar to the first embodiment.

The fourth embodiment, shown in FIG. 4 differs from the third embodiment in that an elevation 18 is arranged to protrude from the portion 15 and that the feed portion is arranged on the elevation, similar to what is shown in the second embodiment. The radiating structure 20 can be of the same kind as in the previous embodiments, even if meander patterns are shown.

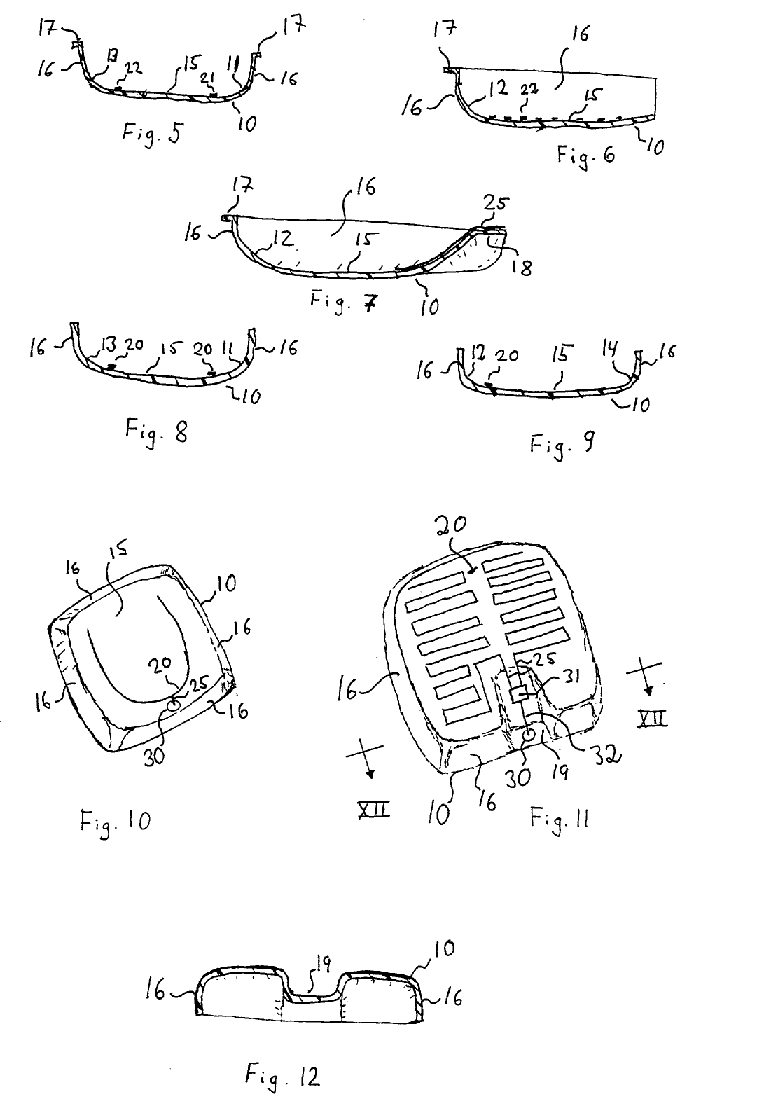

FIGS. 5-9 show the cross sections taken at V-V, VI-VI, VII-VII, VIII-VIII and IX-IX in FIGS. 1, 2 and 3, respectively.

FIG. 10 shows a fifth embodiment similar to the third embodiment. Here however, the radiating structure 20 is located on the surface of the carrier where the portion 15 is not enclosed by the wall portions 16, i.e. on the outside of the trough-shaped carrier, which then will be the first surface. The radiating structure 20 can be of the same kind as in the previous embodiments, even if a bent dipole is shown. The feed portion can be led through a hole 30 in the carrier in order to be connected at the side facing a PCB carrying transceiver circuits of the radio communication device.

In the sixth embodiment, shown in FIG. 11 the carrier has the same shape as in the fifth embodiment except for the recess 19. The recess 19 corresponds to the protruding elevation on the other side, inside the trough-shaped structure, described above. The radiating structure 20 comprises two meander patterns with feed portions 25. The feed portions 25 are connected to a matching means 31, which is connected to the transceiver circuits by means of a connection 32 possibly led through a hole 30. The matching means is used for providing a predetermined impedance, preferably 50 ohm, of the radiating structure, towards the connected circuits. The radiating structure 20 can alternatively be of any kind as mentioned above. Also here the feed portion 25 can be led through a hole 30 in the carrier 10 in order to be connected on the other side.

In FIGS. 10 and 11 the wall portions 16 are shown without rims 17. However the wall portions 16 can be provided with such rims, as in the previous embodiments.

FIG. 12 shows the cross section taken at XII-XII in FIG. 11.

In the previous embodiments a radiating structure 20 has been provided on the first surface of the carrier. However, it can be advantageous when a radiating structure 20 is arranged on both surfaces of the carrier 10. Then the different structures can be arranged to operate in different frequency bands. Even one radiating structure 20 can be arranged to operate in different frequency bands.

In connection with all previous embodiments a ground plane means is preferably arranged essentially parallel with the respective radiating structure(s). The ground plane means can comprise a dielectric carrier or support provided with a conductive coating, layer or pattern, being connected to signal ground of the radio communication device. The connection can be conductive or capacitive. Preferably the rims or the free edges of the wall portions, or parts thereof contact the ground plane means, which is provided on a PCB for transceiver circuits of the radio communication device. By this arrangement the circuits are effectively shielded, and currents induced in the circuits by the radiating structure(s) are avoided or reduced. It is also obtained by this arrangement, that the ground plane means and the radiating structure 20 are well separated. This separation is optimised when the side(s) of the carrier 10 possibly with the radiating structure 20 facing the housing of the radio communication device is conform with and placed close to or in contact with the corresponding part of the housing, and the ground plane means is arranged on a PCB for transceiver circuits of the radio communication device. This is very advantageous, since an optimised volume between the radiating structure 20 and the ground plane means optimises the performance of the antenna means. It is well known by those skilled in the art that the relative bandwidth multiplied with the efficiency is limited by the volume expressed in square wavelength, or:

_{ƒ}^{Δƒ}×n=k×λ²,

where k is a constant.

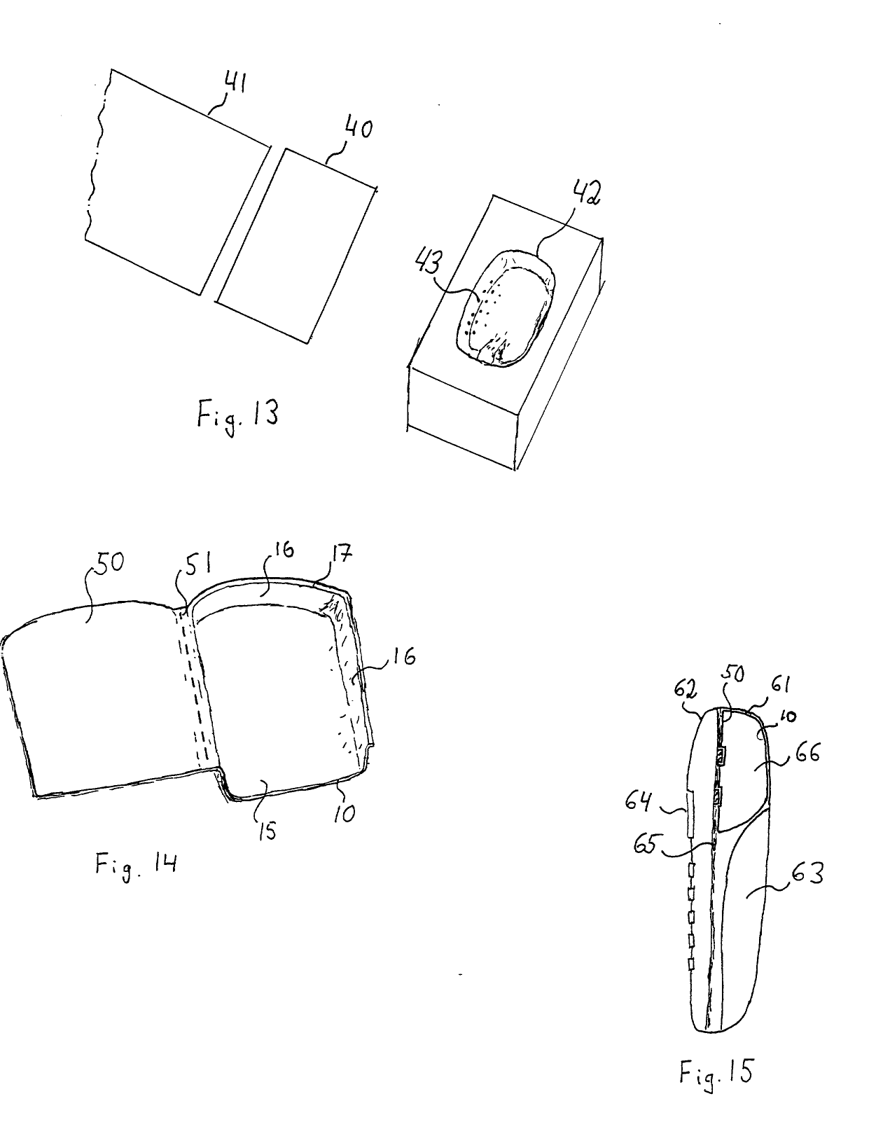

FIG. 13 shows diagrammatically a method for shaping the carrier. A polymer sheet 40 or a band 41 is first heated by e.g. a radiation heater and then placed in a vacuum forming die. Thereafter the air is evacuated from the die through evacuation holes 43 (all not shown) or channels provided in the die. By the vacuum so created, the heated polymer sheet will be brought into contact with the walls of the die, and take their shape after cooling. Additionally an air-tight chamber can be placed on top of the die together with means for obtaining an air-tight connection between the die and the chamber. An air-pressure created in the chamber will act on the sheet to press it against the walls of the die, and thereby adding extra forces on the sheet in addition to the forces caused by the vacuum. Preferably the sheet is large or the band is wide, so that a number of dies can be arranged beside each other, whereby a number of carriers can be shaped at the same time. The so vacuum formed or vacuum thermoformed carriers are then cut out from the sheet e.g. by die cutting. Since the bent portions, being approximately 90°, at the top portions of the wall portions 16, are formed in the vacuum forming process, it can be decided by selecting die cutting tool whether the carrier 10 should be provided with rims or not.

The radiating structure 20 is preferably attached to the carrier in connection with the vacuum forming. The radiating structure 20 can be put in the die before the forming and adhered to the sheet by means of an adhesive or by fusing during the forming. Alternatively the radiating structure 20 can be attached to the sheet e.g. by means of an adhesive before the forming.

In FIG. 13 the die 42 is a female die. However the die could be a positive die (male die).

In order to obtain a carrier 10 with a radiating structure 20 that is conform with a part of the housing of the radio communication device at which it is to be mounted for optimal use of the available space, the die 42 has essentially the same shape as said part of the housing.

When shaping the carrier by vacuum forming or vacuum thermoforming it is advantageous to form a carrier and a ground plane means support in the same process. In FIG. 14 a carrier 10 and a ground plane means support 50 so formed from the same sheet and forming a unitary part are shown. The portion connecting the carrier 10 and the ground plane means support 50 is provided with a bending initiator 51, e.g. a bending line or a perforation.

The surface of the ground plane means support 50 which is seen in FIG. 14 is provided with a conductive layer or pattern which is connectable to signal ground of the radio communication device. The conductive layer or pattern can be applied in the same manner as the radiating structure. The ground plane means support 50 is to be folded over the carrier 10 by bending along the bending initiator. The ground plane means support 50 can be folded approximately 180° in relation to the carrier 10 until it, along its edges, bears on the rims 17. The edges can be fastened to the rims 17 by means of an adhesive, fusing or other suitable means, to form a stable and robust unit. To improve the efficient use of the space, the ground plane means support 50 can be shaped to be conform with a PCB with which it will be in contact in the radio communication device. This is made in the vacuum forming process. It is necessary to have a ground plane means in a device of this kind where the distance between the radiating structure and the PCB is short, due to the coupling effect between them. A conventional ground plane means, such as a metallised plastic cover over the PCB, occupies unnecessary space. It is therefore advantageous when the support of the ground plane means is conform with the underlying PCB, so that even components protruding prom the PCB are received in corresponding recesses formed in the support of the ground plane means, e.g. during the vacuum thermoforming of the polymer sheet.

The carrier 10 is shown to have three wall portions and to have the radiating structure 20 on the surface of the carrier 10 not shown. However, the carrier 10 and the radiating structure 20 could be formed and placed as in any of the previous embodiments.

Plastic materials that can be vacuum formed and are suitable for forming the carrier are for example PVC, PET, PP, PE, PS, PC or combinations as PC/polyester.

In FIG. 15 a hand portable telephone is shown in a schematic cross section. To the back part 61 of the housing a battery 63 is attached. The front part 62 of the housing carries a display 64. The reference numeral 65 denotes a PCB. The antenna means 66 has a carrier 10 which is essentially conform with the portion of the housing where it is mounted. Preferably the carrier is arranged and shaped so as to leave a minimum of space between a portion of the inner wall of the housing and major part of a surface of the carrier possibly with an attached radiating structure.

The ground plane means support 50 is placed to be in contact with the PCB and is formed to receive components protruding from the PCB. The antenna means 66 can be fastened by means of an adhesive, clamp, snap action or similar to the back part of the housing 61 or to the PCB 65.

Through the curved portions and additionally through the bent portions, the carrier will be robust and exhibit a good stability. This is advantageous, since the form stability is important so that the distances between the radiating structure 20 and the ground plane means as well as other adjacent parts are well defined and do not change and cause detuning.

Although the invention is described by means of the above examples, naturally, many variations are possible within the scope of the invention. The carrier could for example form a part of the housing. Further the feed portions can be connected to the transceiver circuits conductively or capacitively.

1. An antenna device for transmitting/receiving RF waves to be arranged in a radio communication device, comprising:
a carrier having first and second surfaces carrying a radiating structure on the first surface,
a feed portion being connectable to transceiver circuits of the radio communication device and being arranged on the carrier and forming a part of the radiating structure, and
a ground plane means,
characterised in
that the carrier has, in a first plane essentially perpendicular to the first surface, a cross section where the first surface exhibits at least a first curved portion,
that the carrier has, in a second plane essentially perpendicular to the first plane and essentially perpendicular to the first surface, a cross section where the first surface exhibits at least a second curved portion, and
that at least two curved portions meet.

2. An antenna device according to claim 1, wherein
the carrier has, in the second plane, a cross section where the first surface further exhibits a third curved portion.

3. An antenna device according to claim 1, wherein
the carrier has, in the first plane, a cross section where the first surface further exhibits a fourth curved portion.

4. An antenna device according to claim 1, wherein
the curved portions surround an essentially planar or very smoothly curved portion,
the carrier has wall portions around the curved portions, each wall portion 16 is provided with a rim 17 formed outside bent portions being approximately 90°, at a side of the wall opposite to that of the curved portion.

5. An antenna device according to claim 1, wherein
the carrier carries a radiating structure on the second surface, in order to provide operation in at least two frequency bands.

6. An antenna device according to claim 1, wherein
each radiating structure(s) is operable in at least two frequency bands.

7. An antenna device according to claim 1, wherein
the carrier is thin and with essentially uniform thickness, the thickness being in the range some tenth of a millimeter to a few millimeters, preferably 0.2-1 millimeter.

8. An antenna device according to claim 1, wherein
the carrier is made from a polymeric sheet-like material.

9. An antenna device according to claims 1, wherein
the carrier is made from a polymeric sheet-like material which is vacuum formed.

10. An antenna device according to claim 8, wherein
a ground plane means support is formed from the same sheet-like material as the carrier,
a conductive structure, possibly conductively connectable to signal ground of the transceiver circuits of the radio communication device, being arranged on the ground plane means support.

11. An antenna device according to claim 8, wherein
a ground plane means support is formed from the same sheet-like material as the carrier,
a conductive structure, possibly capacitively connectable to signal ground of the transceiver circuits of the radio communication device, being arranged on the ground plane means support.

12. An antenna device according to claim 10, wherein
a bending initiator is arranged between the carrier and the ground plane means support in order to enable the ground plane means support to be bent approximately 180° in relation to the carrier.

13. An antenna device according to claim 1, wherein
the ground plane means has one surface which is formed essentially conform with a printed circuit board of the radio communication device, the ground plane means is arranged to be mounted in connection with said printed circuit board.

14. An antenna device according to claim 1, wherein
the carrier is arranged to be essentially conform with a part of an interior of a housing of the radio communication device.

15. An antenna device according to claim 1, wherein
the carrier is essentially trough-shaped.

16. An antenna device according to claim 1, wherein
the radiating structure comprises at least one of the radiating structures selected from the group consisting of meander patterns, loops, patches, bent dipoles and fractals.

17. An antenna device according to claims 1, wherein
the radiating structure extends over at least one of said curved portions.

18. An antenna device according to claims 1, wherein
a convex and a concave surface is formed on the carrier by the curved portions,
an elevation on the carrier carrying the feed portion is protruding from the concave surface.

19. An antenna device according to claim 1, wherein
a matching means is arranged on the carrier and connected at a first end to the feed portion and connectable to the transceiver circuits of the radio communication device at a second end, such that the radiating structure is connectable to the transceiver circuits via the matching means.

20. A method for manufacturing an antenna device according to any of claims 1-19, characterised in
that at least a part of the carrier is formed by means of a die having essentially the same shape as a portion of an inner wall of a housing of the radio communication device.

21. A method according to claim 20, wherein
the radiating structure is placed in the die before the shaping of the carrier, and
the radiating structure is applied to the carrier during the shaping process.
